(19) United States
(12) Patent Application Publication
(10) Pub. No.: US 2023/0267306 A1
(43) Pub. Date: Aug. 24, 2023

(54) MACHINE-LEARNING TECHNIQUES FOR REPRESENTING ITEMS IN A SPECTRAL DOMAIN

(71) Applicant: NVIDIA CORPORATION, Santa Clara, CA (US)

(72) Inventors: Benjamin ECKART, Oakland, CA (US); Jan KAUTZ, Lexington, MA (US); Chao LIU, Pittsburgh, PA (US); Benjamin WU, Oviedo, FL (US)

(21) Appl. No.: 17/933,806

(22) Filed: Sep. 20, 2022

Related U.S. Application Data
(60) Provisional application No. 63/313,701, filed on Feb. 24, 2022.

(51) Int. Cl. G06N 3/04; G06T 5/10

(52) U.S. Cl. CPC G06N 3/0454; G06T 5/10; G06T 2207/20056

(57) ABSTRACT

In various embodiments, a training application generates a trained machine learning model that represents items in a spectral domain. The training application executes a first neural network on a first set of data points associated with both a first item and the spectral domain to generate a second neural network. Subsequently, the training application generates a set of predicted data points that are associated with both the first item and the spectral domain via the second neural network. The training application generates the trained machine learning model based on the first neural network, the second neural network, and the set of predicted data points. The trained machine learning model maps one or more positions within the spectral domain to one or more values associated with an item based on a set of data points associated with both the item and the spectral domain.

### CROSS-REFERENCE TO RELATED APPLICATIONS

This application claims priority benefit of the U.S. Provisional Patent Application titled, “DEEP LEARNING TECHNIQUES FOR RECONSTRUCTING IMAGES,” filed on Feb. 24, 2022, and having Ser. No. 63/313,701. The subject matter of this related application is hereby incorporated herein by reference.

### BACKGROUND

### Field of the Various Embodiments

The various embodiments relate generally to computer science and artificial intelligence and, more specifically, to machine-learning techniques for representing items in a spectral domain.

### Description of the Related Art

Astronomical interferometry is the process of combining signals from a collection of telescopes to approximate a high-resolution astronomical image depicting fine details of an astronomical object that could not be detected using any of the telescopes in isolation. A typical interferometer combines signals from pairs of telescopes over time to generate samples of a spatial coherence function in a Fourier domain. Each sample is a measurement known as a “visibility” that reflects how signals from at least two telescopes observing the same astronomical object at the same wavelength and at the same time interact when combined.

Notably, for relatively small fields of view, the spatial coherence function of an observed astronomical object is the inverse two-dimensional (2D) Fourier transform of a corresponding astronomical image in an image plane. If the Fourier domain can be densely sampled, then an inverse 2D Fourier transform can be used to construct the corresponding astronomical image with a relatively high level of accuracy. In practice, however, because an interferometer generates visibilities based on a relatively small number of stationary telescopes, the Fourier domain usually is sparsely sampled. Computing an inverse 2D Fourier transform based on sparsely sampled data typically produces a distorted image. Thus, computing the inverse 2D Fourier transform based on sparsely sampled visibilities produced by an interferometer oftentimes yields a distorted image of a corresponding astronomical object known as a “dirty” image, instead of producing an accurate representation of the corresponding astronomical object.

In one approach to constructing more accurate astronomical images from sparsely sampled visibilities, a CLEAN-based model is used to iteratively “fill-in” various gaps in the data represented in the Fourier domain. More precisely, the CLEAN-based model implements heuristics that iteratively approximate unsampled portions of the Fourier domain using uncorrelated point sources. One imitation of CLEAN-based models, though, is that the underlying simplifying assumption that an astronomical object can be accurately represented as a set of uncorrelated point sources is inherently limiting for astronomical objects that are sources of extended emissions. For these types of astronomical objects, CLEAN-based models can generate visual errors or “processing artifacts” that can substantially reduce the accuracy of the images produced using the inverse 2D Fourier transforms. Some examples of astronomical objects that can be sources of extended emissions include, without limitation, galaxies, planetary nebulae, black holes, interstellar gas clouds, and supernova remnants.

Another limitation of CLEAN-based models is that, irrespective of the type of emissions, constructing plausible images of astronomical objects oftentimes requires manually tuning certain parameters in a lengthy iterative process that varies from user to user. In practice, this type of manual tuning can introduce personal biases into the image construction process that, in turn, can reduce the overall accuracy of the images that ultimately are produced.

Even though the above discussion focuses on certain specific problems arising in astronomical interferometry, as a more general matter, producing accurate images from sparsely sampled data is a difficult technical problem that exists in many applications outside of astronomical interferometry.

As the foregoing illustrates, what is needed in the art are more effective techniques for constructing images from sparsely sampled data.

### SUMMARY

One embodiment of the present invention sets forth a computer-implemented method for representing items in a spectral domain. The method includes executing a first neural network on a first set of data points associated with both a first item and the spectral domain to generate a second neural network; generating a first set of predicted data points that are associated with both the first item and the spectral domain via the second neural network; and generating a trained machine learning model based on the first neural network, the second neural network, and the first set of predicted data points, where the trained machine learning model maps one or more positions within the spectral domain to one or more values associated with an item based on a set of data points associated with both the item and the spectral domain.

At least one technical advantage of the disclosed techniques relative to the prior art is that the disclosed techniques can be used to construct substantially more accurate images from sparsely sampled data relative to what can be achieved using prior art approaches. In the specific context of astronomical interferometry, the disclosed techniques are able to generate substantially more accurate images of a wider range of astronomical objects based on sparsely sampled visibilities relative to what can be achieved using conventional approaches. Among other things, in the disclosed approach, a machine learning model is trained to map sparsely sampled visibilities to an implicit dense representation in the Fourier domain. Because the trained machine learning model generates the implicit dense representation based on arbitrarily complex patterns gleaned from training data, the accuracy of an image generated using the disclosed techniques can be significantly increased relative to prior art approaches that implement simplifying assumptions that oftentimes prove to be quite limiting. Another advantage of the disclosed techniques is that, because the parameters associated with the machine learning model are automatically adjusted during training to reduce reconstruction errors, personal biases that can reduce the accuracy of prior art models are reduced. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is a more detailed illustration of the spectral reconstruction model of FIG. 1, according to various embodiments;

FIGS. 3A-3B set forth a flow diagram of method steps for training a machine learning model to map spectral positions to predicted visibilities for an astronomical object, according to various embodiments; and

FIG. 4 is a flow diagram of method steps for generating an astronomical image using a trained machine learning model, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are denoted with reference numbers identifying the object and parenthetical alphanumeric character(s) identifying the instance where needed.

### System Overview

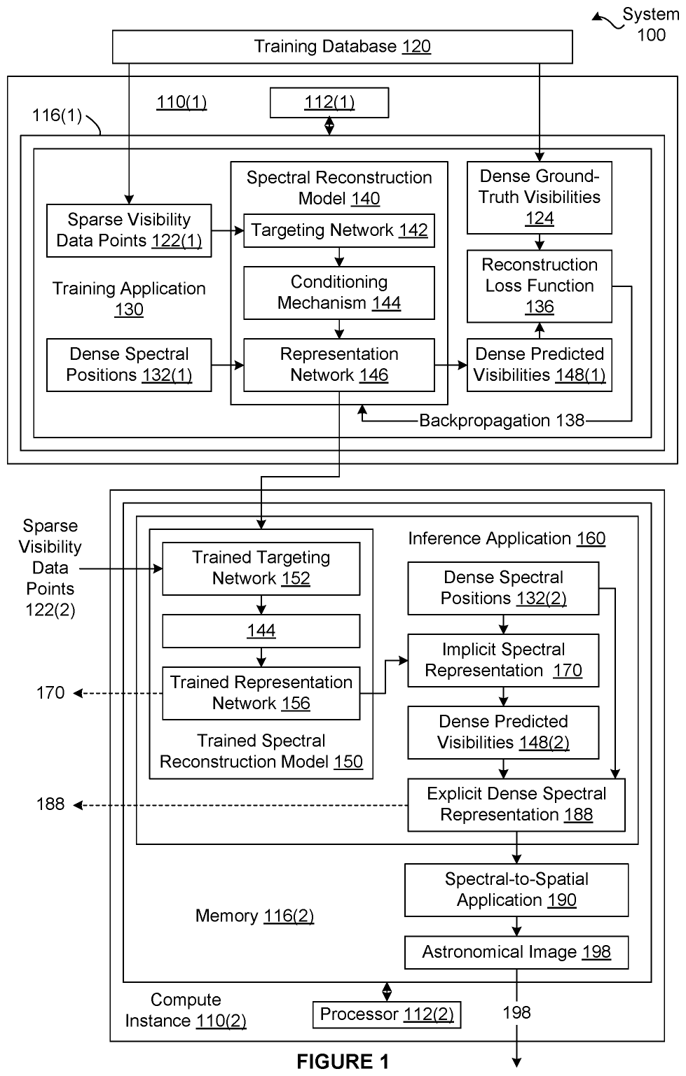

FIG. 1 is a conceptual illustration of a system 100 configured to implement one or more aspects of the various embodiments. As shown, in some embodiments, the system 100 includes, without limitation, a compute instance 110(1), a compute instance 110(2), and a training database 120. In some other embodiments, the compute instance 110(1), the compute instance 110(2), the training database 120, or any combination thereof can be omitted from the system 100. In the same or other embodiments, the system 100 can include, without limitation, any number of other compute instances and any number (including none) and/or types of databases. In some embodiments, the components of the system 100 can be distributed across any number of shared geographic locations and/or any number of different geographic locations and/or implemented in one or more cloud computing environments (i.e., encapsulated shared resources, software, data, etc.) in any combination.

As shown, the compute instance 110(1) includes, without limitation, a processor 112(1) and a memory 116(1), and the compute instance 110(2) includes, without limitation, a processor 112(2) and a memory 116(2). For explanatory purposes, the compute instance 110(1) and the compute instance 110(2) are also referred to herein individually as a “compute instance 110” and collectively as “compute instances 110.” The processor 112(1) and the processor 112(2) are also referred to herein individually as a “processor 112” and collectively as “processors 112.” The memory 116(1) and the memory 116(2) are also referred to herein individually as a “memory 116” and collectively as “memories 116.” Each of the compute instances 110 can be implemented in a cloud computing environment, implemented as part of any other distributed computing environment, or implemented in a stand-alone fashion.

The processor 112 can be any instruction execution system, apparatus, or device capable of executing instructions. For example, the processor 112 could be a central processing unit, a graphics processing unit, a controller, a micro-controller, a state machine, or any combination thereof. The memory 116 of the compute instance 110 stores content, such as software applications and data, for use by the processor 112 of the compute instance 110. The memory 116 can be one or more of a readily available memory, such as random-access memory, read-only memory, floppy disk, hard disk, or any other form of digital storage, local or remote.

In some other embodiments, each compute instance 110 can include any number of processors 112 and any number of memories 116 in any combination. In particular, any number of compute instances 110 (including one) and/or any number of other compute instances can provide a multiprocessing environment in any technically feasible fashion.

In some embodiments, a storage (not shown) can supplement or replace the memory 116 of the compute instance 110. The storage can include any number and type of external memories that are accessible to the processor 112 of the compute instance 110. For example, and without limitation, the storage can include a Secure Digital Card, an external Flash memory, a portable compact disc read-only memory, an optical storage device, a magnetic storage device, or any suitable combination of the foregoing.

In general, each compute instance 110 is configured to implement one or more software applications. For explanatory purposes only, each software application is described as residing in the memory 116 of a single compute instance (e.g., the compute instance 110(1) or the compute instance 110(2)) and executing on the processor 112 of the single compute instances. In some embodiments, any number of instances of any number of software applications can reside in the memory 116 and any number of other memories associated with any number of other compute instances and execute on the processor 112 of the compute instance 110 and any number of other processors associated with any number of other compute instances in any combination. In the same or other embodiments, the functionality of any number of software applications can be distributed across any number of other software applications that reside in the memory 116 and any number of other memories associated with any number of other compute instances and execute on the processor 112 and any number of other processors associated with any number of other compute instances in any combination. Further, subsets of the functionality of multiple software applications can be consolidated into a single software application.

In some embodiments, the compute instance 110(2) is configured to predict dense spectral data points associated with an item and optionally an image associated with the item based on sparse spectral data points associated with the item. In the same or other embodiments, each spectral data point includes, without limitation, a position in a spectral domain and at least one value that is associated with the spectral domain and corresponds to the position. For explanatory purposes, positions and values that are associated with a spectral domain are also referred to herein as “spectral positions” and “spectral values,” respectively. Some examples of spectral domains include, without limitation, a Fourier or “frequency” domain, a cepstral domain, and a wavelet domain.

Please note that the terms “dense” and “densely-sampled” are used herein interchangeably. As used herein, in some embodiments if an object is “densely-sampled,’ then a corresponding measurement exists for each discrete sampling position in a set (e.g., a grid) of discrete sampling positions (e.g., pixel coordinates for an image). For example, if an image having a size of 256 pixels×256 pixels or “256×256” is densely-sampled, then a corresponding measurement (e.g., a red color value, a green color value, and a blue color value) exists for each of 256×256 pixel coordinates (i.e., sampling positions in a 256×256 grid). If an image is densely-sampled, then the corresponding image measurement is also referred to herein as “dense image measurement.” In the context of interferometry, sampling positions for a spectral measurement can be discretized in a similar fashion. In some embodiments, if a spectral measurement exists for each discrete sampling position in a set of sampling positions, then the corresponding spectral measurement is also referred to herein as “dense spectral measurement.” In some other embodiments, if an object is “densely-sampled,” then a corresponding measurement exists for each of a relatively high percentage (e.g., ninety percent or higher) of discrete sampling positions in a set of discrete sampling positions.

Please also note that he terms “sparse” and “sparsely-sampled” are used herein interchangeably. As used herein, in some embodiments if an object is “sparsely-sampled,’ then a corresponding measurement exists for each of only a relatively small percentage (e.g., less than five percent) of discrete sampling positions in a set of discrete sampling positions. Accordingly, if an object is “sparsely-sampled,” then no corresponding measurements exist for a relatively large percentage (e.g., greater than 95%) of discrete sampling positions in a set of discrete sampling positions.

In some embodiments, an image associated with an item is a 2D visual representation associated with both the item and a spatial domain. A spatial domain is also commonly referred to as a “normal image space” and an “image plane.” In some embodiments, an image includes, without limitation, any number of picture elements or “pixels,” where each pixel is associated with a position in a spatial domain and at least one component associated with the spatial domain. In some embodiments, a pixel in a grayscale image is associated with a single component that is also referred to herein as a “brightness” and an “intensity.” In the same or other embodiments, a pixel in a color image can be associated with one, two, or three components in accordance with an associated color space and any associated chroma subsampling type.

In some embodiments, an image includes, without limitation, any number of picture elements or “pixels,” where each pixel is associated with a position in a spatial domain and at least one component associated with the spatial domain. In the same or other embodiments, a position within the spatial domain is an ordered pair of coordinates. In some embodiments, a pixel in a grayscale image is associated with a single component that is also referred to herein as a “brightness” and an “intensity.” In the same or other embodiments, a pixel in a color image can be associated with one, two, or three components in accordance with an associated color space and any associated sub-sampling type. In some embodiments, each component of a pixel is also referred to herein as a “pixel value.”

As persons skilled in the art will recognize, the disclosed techniques can be used to predict any number and/or types of dense spectral data and/or any number and/or types of images based on sparse spectral data associated with any number and/or types of items and any number and/or types of spectral domains. Accordingly, the disclosed techniques can be used to solve different types of technical problems associated with a wide range of fields.

For explanatory purposes, however, FIGS. 1-4 and the description below focus generating dense spectral data points associated with both an astronomical object and a Fourier domain and grayscale astronomical images based on sparse spectral data points associated with both the astronomical object and the Fourier domain. When observing an astronomical object, a typical interferometer produces sparse spectral values known as “visibilities” corresponding to different positions within the Fourier domain. Accordingly, in some embodiments, each spectral data point is a visibility data point that includes, without limitation, a position within the Fourier domain and a corresponding visibility associated with an astronomical object.

As used herein, a “visibility” is a sample of a spatial coherence function in a Fourier domain. In some embodiments, the spatial coherence function of an astronomical object is a complex function that is denoted herein as V(u,v), where u and v denote a u-coordinate and a v-coordinate, respectively, of a UV coordinate system associated with the Fourier domain. In the same or other embodiments, a visibility is a complex value in the Fourier domain corresponding to a position specified as an ordered pair of a u-coordinate and a v-coordinate.

As per the van Cittert-Zernike theorem, an intensity distribution of an astronomical object is related to the spatial coherence function of the astronomical object via a 2D Fourier transform (symbolized herein as [symbol] ). In the same or other embodiments, the intensity distribution of an astronomical object is denoted as I(l,m), where l and m denote an l-coordinate and an m-coordinate, respectively, of a direction cosine coordinate system or “sky coordinate system” associated with a spatial domain. In some embodiments, the relationship between the intensity distribution of an astronomical object and the spatial coherence function can therefore be expressed as any of equation (1)-equation (4):

V(u,v)= [symbol] [I(l,m)] (1)

V(u,v)=∫ₗ∫ₘe^{-2πi(ul+vm)}I(l,m)dldm (2)

I(l,m)= [symbol] ⁻¹[V(u,v)] (3)

I(l,m)=∫ᵤ∫ᵥe^{2πi(ul+vm)}V(u,v)dudv (4)

In some embodiments, the intensity of each pixel in an astronomical image is the value of the intensity distribution for a corresponding astronomical object at a different position within the spatial domain as specified as an ordered pair of an l-coordinate and an m-coordinate. Accordingly, computing an inverse 2D Fourier transform based on dense visibility data points associated with an astronomical object would yield a relatively accurate astronomical image of the astronomical object. In practice, however, computing an inverse 2D Fourier transform based on the sparse visibilities that are actually produced during an interferometric observation of an astronomical object oftentimes yields a distorted and therefore inaccurate astronomical image of the astronomical object.

As described previously herein, in a conventional approach to constructing more accurate astronomical images from sparse visibilities, a CLEAN-based model is used to iteratively approximate unsampled portions of the Fourier domain using uncorrelated point sources. One limitation of CLEAN-based models, though, is that for astronomical objects that are sources of extended emissions, CLEAN-based models can generate visual errors that can substantially reduce the accuracy of the images produced using the inverse 2D Fourier transforms. Another limitation of CLEAN-based models is that, irrespective of the type of emissions, constructing plausible images of astronomical objects oftentimes requires manual tuning of associated parameters. Manually tuning parameters associated with CLEAN-based models can introduce personal biases into the image construction process that, in turn, can reduce the overall accuracy of the images that ultimately are produced.

### Mapping Sparse Spectral Data Points to Dense Spectral Representations

To address the above problems, in some embodiments, the compute instance 110(1) includes, without limitation, a training application 130. As described in greater detail below, in some embodiments, the training application 130 generates a trained spectral reconstruction model 150 that maps sparse visibility data points associated with an astronomical object to an implicit spectral representation associated with the astronomical object. The implicit spectral representation associated with an astronomical object maps positions within the Fourier domain specified via continuous spectral positions to predicted visibilities for the astronomical object. The implicit spectral representation associated with an astronomical object is therefore an implicit and dense representation of the spatial coherence function of the astronomical object.

In the same or other embodiments, the compute instance 110(2) includes, without limitation, an inference application 160 and a spectral-to-spatial application 190. In some embodiments, the inference application 160 generates both an implicit dense spectral representation and an explicit dense spectral representation for each of any number of target astronomical objects. For each target astronomical object, the inference application 160 inputs sparse visibility data points acquired during an interferometric observation of the target astronomical object into the trained spectral reconstruction model 150. In response, the trained spectral reconstruction model 150 generates an implicit spectral representation associated with the target astronomical object. In some embodiments, an implicit spectral representation associated with a target astronomical object is an implicit and dense representation of the spatial coherence function for the target astronomical object.

In some embodiments, after generating an implicit spectral representation associated with a target astronomical object, the inference application 160 inputs dense spectral positions into the implicit spectral representation. In response, the implicit spectral representation generates dense visibilities for the target astronomical object. Collectively, the dense visibilities for the target astronomical object and the corresponding spectral positions are an explicit dense spectral representation associated with the target astronomical object. In some embodiments, an explicit dense spectral representation associated with a target astronomical object is an explicit (e.g., discrete data points) and dense representation of the spatial coherence function for the target astronomical object.

In some embodiments, the spectral-to-spatial application 190 uses an inverse 2D Fourier transform to generate an astronomical image for a target astronomical object based on the explicit dense spectral representation associated with the target astronomical object. In some other embodiments, the spectral-to-spatial application 190 uses an inverse 2D Fourier transform to generate an astronomical image for a target astronomical object based on the dense visibilities for the target astronomical object and optionally the corresponding dense spectral positions. In the same or other embodiments, inference application 160 does not generate an explicit dense spectral representation associated with the target astronomical object.

As referred to herein, an “inverse 2D Fourier transform” refers to any type of inverse 2D Fourier transform and/or associated algorithm. For instance, in some embodiments, the spectral-to-spatial application 190 uses an inverse 2D discrete Fourier transform to generate an astronomical image for a target astronomical object based on the dense visibilities for the target astronomical object and a grid spacing associated with a corresponding grid of dense spectral positions.

As shown, in some embodiments, the training application 130 resides in the memory 116(1) of the compute instance 110(1) and executes on the processor of the compute instance 110(1). In the same or other embodiments, the training application 130 includes, without limitation, a spectral reconstruction model 140, sparse visibility data points 122(1), dense spectral positions 132(1), dense ground-truth visibilities 124, dense predicted visibilities 148(1), and a reconstruction loss function 136. In some other embodiments, the training application 130 and the spectral reconstruction model 140 are implemented as separate components of the system 100.

As described in greater detail below, in some embodiments, the training application 130 executes any number and/or types of machine learning operations and/or algorithms on the spectral reconstruction model 140 based on the training database 120 to generate the trained spectral reconstruction model 150. In some embodiments, the training database 120 includes, without limitation, a different training set of sparse visibility data points and a different ground-truth set of dense visibilities for each of T interferometric observations, where T can be any positive integer. In the same or other embodiments, the T interferometric observations are collectively associated with a variety of astronomical images.

The training application 130 can determine the training database 120 in any technically feasible fashion. For instance, in some embodiments, the training database 120 is pre-generated, and the training application 130 identifies the training database 120 based on configuration information or user input. In some other embodiments, the training application 130 synthesizes the training database 120 based on T or fewer high-resolution training astronomical images. The training application 130 can synthesize the training database 120 in any technically feasible fashion. In some embodiments, the training application 130 performs any number and/or types of sampling operations, interferometric observation simulation operations, non-uniform discrete Fourier transform operations, any number and/or types of other operations, or any combination thereof on the training astronomical image to generate the training database 120.

In some embodiments, each training set includes, without limitation, M visibility data points, where M can be any positive integer that is consistent with sparse sampling associated with an interferometric observation of an astronomical object. In the same or other embodiments, each visibility data point is a tuple that specifies, without limitation, a u-coordinate, a v-coordinate, and a visibility at the position in a Fourier domain corresponding to the u-coordinate and the v-coordinate. In some embodiments, the positions associated with a training set reflect a non-uniform sampling pattern representing or simulating an interferometric observation of the associated astronomical object. The positions associated with a training set are also referred to herein as “sparse spectral positions.”

In some embodiments, each ground-truth set includes, without limitation, a different visibility for each of the dense spectral positions 132(1). In the same or other embodiments, the dense spectral positions 132(1) include, without limitation N spectral positions, where N is significantly greater than M and is consistent with a dense sampling of visibility data points that enables construction of a corresponding astronomical image with at least a target level of accuracy or “fidelity.”

In some embodiments, each of the dense spectral positions 132(1) is a position in a Fourier domain and is specified as an ordered pair of a u-coordinate and a v-coordinate. In the same or other embodiments, the dense spectral positions 132(1) form a uniform grid of spectral positions. For example, in some embodiments, the dense spectral positions 132(1) correspond to a 256×256 grid pattern set within the maximum baseline of a target telescope array.

Although not shown, in some embodiments, the dense spectral positions 132(1) and the ground-truth sets of dense visibilities are replaced with ground-truth sets of dense spectral data points, and the techniques described herein are modified accordingly. In the same or other embodiments, the total number of dense spectral positions and/or the dense spectral positions can vary across ground-truth sets of dense spectral data points. In some embodiments, the sparse spectral positions associated with an interferometric observation are a non-uniform subset of the dense spectral positions associated with the interferometric observation.

The spectral reconstruction model 140 can be any type of machine learning (ML) model having any number and/or types of learnable parameters, any number and/or types of data-dependent parameters, and inductive biases that enable the spectral reconstruction model 140 to learn how to generate an implicit spectral representation based on sparse spectral data points. For explanatory purposes, at any given point-in-time, each parameter associated with the spectral reconstruction model 140 has a value that is also referred to herein as a “parameter value.” As referred to herein, an “implicit spectral representation,” is an approximation of a continuous function that maps a spectral position to a spectral value. Notably, an implicit spectral representation can map continuously varying spectral positions to spectral values. Implicit representations are also commonly referred to as “coordinate-based representations.” As referred to herein, an implicit spectral representation that is associated with an observed item (e.g., an astronomical object) “represents” the observed item within spectral domain.

In some embodiments, the spectral reconstruction model 140 is capable of learning how to generalize across implicit spectral representations, and the training application 130 trains the spectral reconstruction model 140 to generalize using the training database 120. As a result, the trained spectral reconstruction model 150 can accurately map different sets of sparse spectral data points to different and previously unseen implicit spectral representations.

Advantageously, training the spectral reconstruction model 140 to generalize across implicit spectral representations can increase the accuracy of the trained spectral reconstruction model 150. In particular, for very sparse sampling associated with very-long-baseline interferometry, training the spectral reconstruction model 140 to generalize can substantially increase the accuracy of the trained spectral reconstruction model 150. The spectral reconstruction model 140 can implement any number and/or types of techniques and/or design strategies to facilitate generalization.

As shown, in some embodiments, the spectral reconstruction model 140 includes, without limitation, a targeting network 142, a conditioning mechanism 144, and a representation network 146. In some embodiments, the targeting network 142 is an ML model that maps sparse spectral data points to any amount and or types of conditioning information. In the same or other embodiments, the conditioning mechanism 144 modulates data-dependent parameters associated with the representation network 146 based on the conditioning information. In some embodiments, the representation network 146 is an ML model that implements an implicit spectral representation based on the conditioning information.

In some other embodiments, the targeting network 142 directly modules data-dependent parameters associated with the representation network 146, the conditioning mechanism 144 is omitted from the spectral reconstruction model 140, and the techniques described herein are modified accordingly. In yet other embodiments, the targeting network 142 can generate or modify the representation network 146 in any technically feasible fashion instead of or in addition to via the conditioning mechanism 144, and the techniques described herein are modified accordingly.

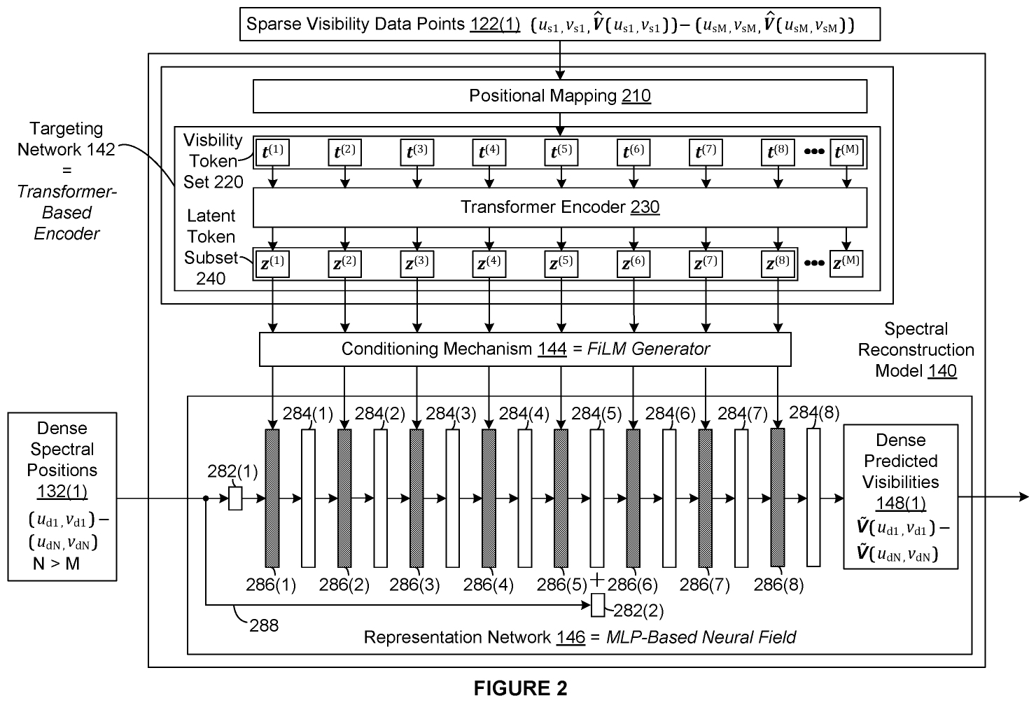

In some embodiments, the targeting network 142 can be any type of ML model having any number and/or types of learnable parameters and inductive biases that enable the targeting network 142 to learn how to map sparse spectral data points to any amount and/or types of conditioning information. In the same or other embodiments, the conditioning information directly or indirectly transforms the representation network 146 into a corresponding implicit spectral representation. As described in greater detail below in conjunction with FIG. 2, in some embodiments, the targeting network 142 is a neural network that is based on a transformer encoder. In some other embodiments, the targeting network 142 is a neural network that is based on a variational encoder. In yet other embodiments, the targeting network 142 is based on learnable neural splines.

In some embodiments, as the training application 130 trains the spectral reconstruction model 140, the training application 130 learns prior knowledge from multiple training sets included in the training database 120 to generate conditioning information corresponding to different implicit spectral representations. Accordingly, in some embodiments, the targeting network 142 enables a single trained spectral reconstruction model (e.g., the trained spectral reconstruction model 150) to generate different implicit spectral representations without retraining.

In some embodiments, the conditioning mechanism 144 modifies the functionality of the representation network 146 based on any amount and/or types of conditioning information generated by the targeting network 142 in any technically feasible fashion. In particular, in some embodiments, the conditioning mechanism 144 sets the values of each of any number of data-dependent parameters associated with the representation network 146 based on conditioning information generated by the targeting network 142. In the same or other embodiments, the targeting network 142 and/or the representation network 146 can implement any number and/or types of techniques to interface indirectly via the conditioning mechanism 144.

As described in greater detail below in conjunction with FIG. 2, in some embodiments, the conditioning mechanism 144 is a feature-wise linear modulation (FiLM) generator that maps conditioning information to values of data-dependent parameters known as “FiLM parameters.” In the same or other embodiments, an underlying architecture of the representation network 146 is augmented with FiLM layers that are parameterized by the FiLM parameters. In some embodiments, the FiLM parameters are data-dependent scale parameters or “scaling coefficients” and/or data-dependent shift parameters or “shifting coefficients,” and the FiLM layers scale and/or shift inputs to any number of layers in the underlying architecture of the representation network 146.

In some embodiments, the representation network 146 can be any type of ML model having any number and/or types of learnable parameters and inductive biases that enable the representation network 146 to learn how to approximate a continuous function that maps spectral positions to spectral values and is generalized via conditioning. In the same or other embodiments, the representation network 146 has any number and/or types of data-dependent parameters, optionally any number and/or types of conditioning layers (e.g., FiLM layers), and optionally any number and/or types of other features that are associated with any number and/or types of conditioning mechanisms.

In some embodiments, the representation network 146 is a neural network that is modulated via conditioning to implement different implicit spectral representations. Implicit representations implemented via neural networks are also commonly referred to as “neural implicit representations,” “coordinate-based neural representations,” and “neural fields.” In particular, in some embodiments, the representation network 146 is a Multi-Layer Perceptron (MLP) that is augmented with FiLM layers parameterized via FiLM parameters.

The training application 130 can execute any number and/or types of machine learning operations and/or algorithms on the spectral reconstruction model 140 to jointly learn the learnable parameters associated with the spectral reconstruction model 140 based on any number and/or types of optimization criteria. Some examples of learnable parameters include, without limitation, weights and biases. As used herein, the “learnable parameters associated with the spectral reconstruction model 140” refer to the learnable parameters across every level of hierarchy within the spectral reconstruction model 140.

For explanatory purposes, the functionality of the training application 130 in some embodiments is described below in greater detail in the context of training the spectral reconstruction model 140 depicted in FIG. 1 in an end-to-end fashion using an exemplary iterative learning algorithm. The exemplary iterative learning algorithm jointly optimizes the learnable parameters associated with the targeting network 142 and the learnable parameters associated with the representation network 146 based on the reconstruction loss function 136 to train the spectral reconstruction model 140. As described below, in some embodiments, the training application 130 executes the exemplary iterative learning algorithm over the training database 120 for any number of epochs based on a mini-batch size of one. For explanatory purposes, each epoch corresponds to the T interferometric observations represented in the training database 120 and each mini-batch corresponds to one interferometric observation.

Many modifications and variations on the functionality of the exemplary iterative learning algorithm, the spectral reconstruction model 140, the training database 120, and the reconstruction loss function 136 as described herein will be apparent to those of ordinary skill in the art without departing from the scope and spirit of the described embodiments. For instance, in some other embodiments, the training application 130 can execute the exemplary iterative training algorithm for any number of epochs based on any mini-batch size and the techniques described below are modified accordingly. In general, the spectral reconstruction model 140 can execute any number and/or types of training operations, algorithms, processes, or any combination thereof on the spectral reconstruction model 140 to train the spectral reconstruction model 140 in any technically feasible fashion that is based, at least in part, on reducing a reconstruction loss.

For explanatory purposes, FIG. 1 depicts the training application 130 in some embodiments during an interval in time corresponding to a single iteration of the exemplary iterative learning algorithm. In some embodiments, to initiate each iteration, the training application 130 selects one of the interferometric observations represented by the training database 120. The training application 130 sets the sparse visibility data points 122(1) equal to a training set of sparse visibility points associated with the selected interferometric observation and included in the training database 120. The training application 130 sets the dense ground-truth visibilities 124 equal to the training set of sparse visibility points associated with the selected interferometric observation and included in the training database 120.

Subsequently, the training application 130 propagates the sparse visibility data points 122(1) through the spectral reconstruction model 140 in a forward direction. More specifically, in some embodiments, the training application 130 inputs the sparse visibility data points 122(1) into the targeting network 142. In response, the targeting network 142 computes conditioning information (not shown) based on the current values of any number of learnable parameters included in the targeting network 142.

As shown, in some embodiments, the conditioning mechanism 144 computes observation-specific values for any number of data-dependent parameters included in the representation network 146 based on the conditioning information. The resulting version of the representation network 146 is also referred to herein as a: conditioned representation network.” In some embodiments the conditioned representation network includes, without limitation, current values for any number of learnable parameters included in the representation network 146 and observation-specific values for the data-dependent parameters included in the representation network 146.

Notably, the conditioned representation network is a predicted implicit spectral representation of the astronomical object associated with the selected interferometric observation. To evaluate the accuracy of the predicted implicit spectral representation of the astronomical object, the training application 130 uses the conditioned representation network to generate an explicit dense spectral representation of the astronomical object. As shown, in some embodiments, the training application 130 inputs the dense spectral positions 132(1) into the conditioned representation network. In response, the conditioned representation network generates the dense predicted visibilities 148(1) that include, without limitation, a different ground-truth visibility for each of the dense spectral positions 132(1).

As described previously herein, in some embodiments, the dense ground-truth visibilities 124 include, without limitation, a different ground-truth visibility for each of the dense spectral positions 132(1). In the same or other embodiments, the training application 130 uses the reconstruction loss function 136 to compute a reconstruction loss in the Fourier domain that is associated with the selected interferometric observation based on the dense predicted visibilities 148(1) and the dense ground-truth visibilities 124 for each of the dense spectral positions 132(1).

The reconstruction loss function 136 can define a reconstruction loss or reconstruction error in any technically feasible fashion. As referred to herein, a “reconstruction loss” or a “reconstruction error” quantifies differences between a set of predicted values corresponding to a set of spectral positions and a set of ground-truth values for the set of spectral positions. In some embodiments, the reconstruction loss function 136 measures a mean-squared reconstruction error for N spectral positions included in the dense spectral positions 132(1). In the same or other embodiments, the mean-squared reconstruction error for the N spectral positions is the mean of the squares of N individual errors associated with the N spectral positions. In the same or other embodiments, the reconstruction error associated each spectral position is equal to the predicted visibility for the spectral position that is included in the dense spectral positions 132(1) minus the ground-truth visibility for the dense spectral position that is included in the dense ground-truth visibilities 124.

In some embodiments, to finish each iteration, the training application 130 jointly updates or “learns” the learnable parameters associated with the representation network 146 and the learnable parameters associated with the targeting network 142 to reduce or minimize the reconstruction loss in the Fourier domain as per the reconstruction loss function 136. Collectively, the learnable parameters associated with the representation network 146 and the learnable parameters associated with the targeting network 142 are the learnable parameters associated with the spectral reconstruction model 140 in some embodiments. The training application 130 can jointly update the learnable parameters associated with the spectral reconstruction model 140 in any technically feasible fashion.

As shown, in some embodiments, the training application 130 uses backpropagation 138 to compute the gradient of the reconstruction loss function 136. The gradient of the reconstruction loss function 136 is a vector of the partial derivatives of the reconstruction loss function 136 with respect to each of the learnable parameters associated with the spectral reconstruction model 140. In some embodiments, the training application 130 executes a backpropagation algorithm on the spectral reconstruction model 140 to compute the partial derivatives of the reconstruction loss function 136 with respect to the learnable parameters associated with the spectral reconstruction model 140 in a backward direction though the spectral reconstruction model 140. In the same or other embodiments, the training application 130 therefore traverses the spectral reconstruction model 140 from the output layer of the representation network 146 through the input layer of the targeting network 142 to compute the gradient of the reconstruction loss function 136.

In some embodiments, the training application 130 updates the values for the learnable parameters in the spectral reconstruction model 140 based on the gradient of the reconstruction loss function 136 and a goal of reducing or minimizing the reconstruction loss. The training application 130 can update the values for the learnable parameters in any technically feasible fashion. For instance, in some embodiments, the training application 130 uses an optimization algorithm known as gradient descent to update the values of the learnable parameters in the spectral reconstruction model 140 in accordance with a goal of reaching a local minimum of the reconstruction loss function 136.

In some embodiments, after each iteration, the training application 130 determines whether the spectral reconstruction model 140 is trained. The training application 130 can determine whether the spectral reconstruction model 140 is trained based on any number and/or types of criteria (e.g., after executing a maximum number of epochs or reaching a target value for a training metric). If the training application 130 determines that the spectral reconstruction model 140 is not trained, then the training application 130 executes another iteration of the exemplary iterative learning algorithm.

When the training application 130 determines that the spectral reconstruction model 140 is trained, the training application 130 terminates the training process. For explanatory purposes only, the updated version of the spectral reconstruction model 140 at the end of the training process is also referred to herein as a trained spectral reconstruction model 150. For explanatory purposes, the trained spectral reconstruction model 150 has a “learned” value for each learnable parameter. Learnable parameters having learned values are also referred to herein as “learned parameters.”

As shown, in some embodiments, the trained spectral reconstruction model 150 includes, without limitation, a trained targeting network 152, the conditioning mechanism 144, and a trained representation network 156. The trained targeting network 152 and the trained representation network 156 are the updated versions of the targeting network 142 and the representation network 146, respectively, at the end of the training process and have learned values for each learnable parameter.

The training application 130 can store the trained spectral reconstruction model 150 or the corresponding learned parameters in any number and/or types of memories. In some embodiments, the training application 130 can transmit the trained spectral reconstruction model 150 to any number and/or types of software applications in any technically feasible fashion. As shown, in some embodiments, the training application 130 transmits the trained spectral reconstruction model 150 to the inference application 160.

As shown, in some embodiments, the inference application 160 and the spectral-to-spatial application 190 reside in the memory 116(2) of the compute instance 110(2) and execute on the processor of the compute instance 110(2). In the same or other embodiments, the inference application 160 includes, without limitation, the trained spectral reconstruction model 150, an implicit spectral representation 170, dense spectral positions 132(2), dense predicted visibilities 148(2), and an explicit dense spectral representation 188.

As shown, in some embodiments, the inference application 160 uses the trained spectral reconstruction model 150 to perform sparse-to-dense spectral reconstruction based on sparse visibility data points 122(2) associated with a target interferometric observation of a target astronomical object. In the same or other embodiments, the sparse visibility data points 122(2) include, without limitation, M visibility data points, where M is determined by the trained spectral reconstruction model 150. As described previously herein, in some embodiments, M is the number of visibility data points included in each training set included in the training database 120.

As shown, the inference application 160 inputs the sparse visibility data points 122(2) into the trained targeting network 152 included in the trained spectral reconstruction model 150. In response, the trained targeting network 152 generates any amount and/or types of conditioning information. More specifically, in some embodiments, the training application 130 inputs the sparse visibility data points 122(1) into the targeting network 142. In response, the targeting network 142 computes conditioning information (not shown) based on the current values of any number of learnable parameters included in the targeting network 142.

In some embodiments, the conditioning mechanism 144 computes observation-specific values for any number of data-dependent parameters included in the trained representation network 156 based on the conditioning information. The resulting version of the trained representation network 156 is also referred to herein as the implicit spectral representation 170. The implicit spectral representation 170 includes, without limitation, any number of learned parameters and the observation-specific values for the data-dependent parameters. Notably, the implicit spectral representation 170 is a predicted implicit representation of the target astronomical object in the Fourier domain.

In some embodiments, the implicit spectral representation 170 maps spectral positions to predicted spectral visibilities for the target astronomical object. In the same or other embodiments, the implicit spectral representation 170 can be used to map spectral positions to predicted spectral visibilities for the target astronomical object without extracting the implicit spectral representation 170 from the trained spectral reconstruction model 150. In some embodiments, the implicit spectral representation 170 can be extracted from the trained spectral reconstruction model 150 and used to map spectral positions to predicted spectral visibilities for the target astronomical object in a stand-alone fashion. In particular, in some embodiments, the inference application 160 extracts the implicit spectral representation 170 from the trained spectral reconstruction model 150.

As shown, in some embodiments, the inference application 160 inputs the dense spectral positions 132(2) into the implicit spectral representation 170. The dense spectral positions 132(2) includes, without limitation, any number of positions in a Fourier domain that is consistent with a dense sampling of visibility data points that enables construction of a corresponding astronomical image with at least a target level of accuracy. In some embodiments, each of the positions within the Fourier domain is specified as an ordered pair of a u-coordinate and a v-coordinate. The inference application 160 can determine the dense spectral positions 132(2) in any technically feasible fashion. For instance, in some embodiments, the inference application 160 generates dense spectral positions 132(2) that correspond to a 256×256 grid pattern set within the maximum baseline of the target telescope array associated with the target interferometric observation.

As shown, the implicit spectral representation 170 maps the dense spectral positions 132(2) to dense predicted visibilities 148(2) for the target astronomical object. In some embodiments, for each spectral position included in the dense spectral positions 132(2), the inference application 160 aggregates the spectral position with the corresponding predicted visibility included in the dense predicted visibilities 148(2) to generate a different visibility data point that the inference application 160 adds to the explicit dense spectral representation 188. Accordingly, the explicit dense spectral representation 188 includes, without limitation, a different visibility data point for each of the dense spectral positions 132(2). In some embodiments, the explicit dense spectral representation 188 is an explicit and dense spectral representation associated with the target astronomical object.

The inference application 160 can store the implicit spectral representation 170 and/or the explicit dense spectral representation 188 in any number and/or types of memories. In some embodiments, the inference application 160 can transmit the implicit spectral representation 170 and/or the explicit dense spectral representation 188 to any number and/or types of software applications in any technically feasible fashion. As shown, in some embodiments, the inference application 160 transmits the explicit dense spectral representation 188 to the spectral-to-spatial application 190.

Although not shown, in some embodiments, the inference application 160 can use the trained spectral reconstruction model 150 to map each of any number of sets of sparse visibility data points to an implicit spectral representation of an associated astronomical object and optionally an explicit dense spectral representation of the associated astronomical object. The inference application 160 can store any number of the implicit spectral representations and/or any number of the explicit dense spectral representations in any number and/or types of memories. In some embodiments, the inference application 160 can transmit any number of the implicit spectral representation and/or any number of the explicit dense spectral representation to any number and/or types of software applications in any technically feasible fashion.

As shown, in some embodiments, the spectral-to-spatial application 190 generates an astronomical image 198 of the target astronomical object based on the explicit dense spectral representation 188. The spectral-to-spatial application 190 can generate the astronomical image 198 in any technically feasible fashion. For instance, in some embodiments, the spectral-to-spatial application 190 computes an inverse 2D Fourier transform based on the explicit dense spectral representation 188 to generate the astronomical image 198.

Advantageously, the inference application 160 can generate dense spectral positions 132(2) such that the astronomical image 198 has a target level of accuracy. The spectral-to-spatial application 190 can store the astronomical image 198 in any number and/or types of memories and/or transmit the astronomical image 198 to any number and/or types of software applications in any technically feasible fashion.

Although not shown, in some embodiments, the inference application 160 can transmit any number of explicit dense spectral representations of any number of astronomical objects to the inference application 160. In the same or other embodiments, upon receiving each of any number of explicit dense spectral representations, the spectral-to-spatial application 190 generates an astronomical image of the associated astronomical object. The spectral-to-spatial application 190 can display any number of astronomical images, store any number of astronomical images in any number and/or types of memories, transmit any number of astronomical images to any number and/or types of software applications in any technically feasible fashion, or any combination thereof.

As illustrated by the embodiments of the inference application 160 described in conjunction with FIG. 1, any number and/or types of software applications can use the trained spectral reconstruction model 150 to generate implicit dense spectral representations and/or an explicit dense spectral representations of astronomical objects based on sparse visibility data points obtained during interferometric observations. Any number and/or types of software applications can use the inverse Fourier transform to generate accurate astronomical images based on explicit dense spectral representations generated via the trained spectral reconstruction model 150.

As noted previously herein, some embodiments that use the training application 130, the inference application 160, and the spectral-to-spatial application 190 to generate images of observed astronomical objects based on sparse visibilities are described in FIGS. 1-4 for explanatory purposes. In some other embodiments, the training application 130, the inference application 160, the spectral-to-spatial application 190, or any combination thereof can be modified to perform sparse-to-dense reconstruction of spectral data to solve many other technical problems associated with a wide range of fields. For example, the training application 130, the inference application 160, and the spectral-to-spatial application 190 can be modified to, without limitation, reconstruct magnetic resonance (MR) images based on sparse magnetic resonance imaging (MRI) measurements, reconstruct surfaces based on sparse surface measurements, refine any types of images using deblurring, refine any types of images using deconvolution, refine any types of images using in-painting, or any combination thereof.

Note that the techniques described herein are illustrative rather than restrictive and can be altered without departing from the broader spirit and scope of the invention. Many modifications and variations on the functionality of the training application 130, the exemplary iterative learning algorithm, the spectral reconstruction model 140, the targeting network 142, the conditioning mechanism 144, the representation network 146, the trained spectral reconstruction model 150, the trained targeting network 152, the trained representation network 156, the implicit spectral representation 170, the inference application 160, and the spectral-to-spatial application 190 as described herein will be apparent to those of ordinary skill in the art without departing from the scope and spirit of the described embodiments. Further, in various embodiments, any number of the techniques disclosed herein may be implemented while other techniques may be omitted in any technically feasible fashion. Similarly, many modifications and variations on the training database 120 and the reconstruction loss function 136 as described herein will be apparent to those of ordinary skill in the art without departing from the scope and spirit of the described embodiments.

It will be appreciated that the system 100 shown herein is illustrative and that variations and modifications are possible. For example, the functionality provided by the inference application 160, and the spectral-to-spatial application 190 as described herein can be integrated into or distributed across any number of software applications (including one). Further, the connection topology between the various units in FIG. 1 can be modified as desired.

### Implementing Transformer-Conditioned Implicit Spectral Representations

FIG. 2 is a more detailed illustration of the spectral reconstruction model 140 of FIG. 1, according to various embodiments. In some embodiments, including the embodiments depicted in FIG. 2, the spectral reconstruction model 140 includes, without limitation, targeting network 142 that is a transformer-based encoder, conditioning mechanism 144 that is a FiLM generator, and representation network 146 that is an MLP-based neural field. Because the transformer-based encoder conditions the MLP-based neural field via the conditioning mechanism 144, the spectral reconstruction model 140 can implement different transformer-conditioned implicit spectral representations.

As described previously herein in conjunction with FIG. 1, during training, the training application 130 uses the spectral reconstruction model 140 to map the sparse visibility data points 122(1) associated with a single interferometric observation of an astronomical object to a predicted implicit spectral representation of the astronomical object. In some embodiments, the sparse visibility data points 122(1) include, without limitation, M visibility data points. In the same or other embodiments, each visibility data point is a tuple that specifies, without limitation, a u-coordinate, a v-coordinate, and a visibility at the position in a Fourier domain corresponding to the u-coordinate and the v-coordinate.

For explanatory purposes, the sparse visibility data points 122(1) are denoted herein collectively as {uₛ, vₛ, \hat{V}(uₛ, vₛ)}. The sparse spectral positions of the sparse visibility data points 122(1) are denoted herein individually as (uₛ₁,vₛ₁)-(u_{sM},v_{sM}). The visibilities of the sparse visibility data points 122(1) are denoted herein individually as \hat{V}(uₛ₁,vₛ₁)-\hat{V}(u_{sM},v_{sM}). In some embodiments, each visibility is a complex value, the visibilities \hat{V}(uₛ₁,vₛ₁)-\hat{V}(u_{sM},v_{sM}) have no inherent ordering, and the sparse visibility data points 122(1) collectively form a complex-valued 2D point cloud.

As shown, in some embodiments, the targeting network 142 maps the sparse visibility data points 122(1) to a latent token subset 240 and zero or more other latent tokens. In the same or other embodiments, the latent token subset 240 conditions the representation network 146 via the conditioning mechanism 144. In some embodiments, the latent token subset 240 includes, without limitation, J latent tokens, where J can be any integer that is less than or equal to the total number of sparse visibility data points 122(1) (denoted as M). In some embodiments, J is determined based on the conditioning mechanism 144 and the architecture of the representation network 146. For instance, in some embodiments, J is the number of layers of the representation network 146 that are associated with data-dependent parameters.

In some embodiments, the targeting network 142 is a transformer-based encoder having any number and/or types of learnable parameters (not shown) that are denoted herein collectively as θₜ. For explanatory purposes, the mapping from the sparse visibility data points 122(1) to the latent token subset 240 performed by the targeting network 142 is denoted herein as ψ({uₛ, vₛ, \hat{V}(uₛ, vₛ)}; θₜ).

As used herein, a “mapping” refers to any transformation between one or more “inputs” and one or more “outputs” that is defined via any number and/or types of mapping functions. Each mapping function can operate on any number and/or types of inputs and can generate any number and/or types of outputs. Each mapping function can be defined via any number and/or types of mathematical operations, any number and/or types of other operations, any number and/or types of parameters, any amount and/or types of other data, or any combination thereof. In some embodiments, a trained machine learning model can be any type of machine learning model that has learned one or more functions that map one or more inputs to one or more outputs. The outputs of any type of machine learning model (including a trained machine learning model) are commonly referred to as “predictions.”

As shown, in some embodiments, the targeting network 142 includes, without limitation, a positional mapping 210, a visibility token set 220, a transformer encoder 230, the latent token subset 240, and zero or more discarded latent tokens (not shown). In some embodiments, the positional mapping 210 maps the sparse visibility data points 122(1) to the visibility token set 220. In the same or other embodiments, the visibility token set 220 includes, without limitation, M visibility tokens that are denoted herein as t⁽¹⁾-t^{(M)}. In the same or other embodiments, each visibility token is a vector. The positional mapping 210 can map the sparse visibility data points 122(1) to the visibility token set 220 in any technically feasible fashion.

In some embodiments, for i is an integer from 1 through M, the positional mapping 210 computes a positional encoding for the spectral position (uₛᵢ,vₛᵢ) and then concatenates the positional encoding with \hat{V}(uₛᵢ,vₛᵢ) to generate visibility token t⁽ⁱ⁾. The positional mapping 210 can compute the positional encoding for each spectral position in any technically feasible fashion. Notably, in some embodiments, the positional mapping 210 implements continuous positional encoding (e.g., sinusoidal positional encoding).

In some embodiments, the transformer encoder 230 can be any type of permutation-invariant model that includes, without limitation, any number and/or types of self-attention mechanisms and can map the visibility token set 220 to a latent token set (not explicitly shown). For instance, in some embodiments, the transformer encoder 230 is a permutation-invariant neural network that implements multi-head attention via any number of multi-head self-attention layers. In some embodiments, the latent token set includes, without limitation, M latent tokens that are denoted herein as z⁽¹⁾-z^{(M)}. In the same or other embodiments, each latent token is a vector.

As shown, in some embodiments, the latent token subset 240 of the latent token set conditions the representation network 146 via the conditioning mechanism 144. The remainder of the M latent tokens are discarded and are also collectively referred to herein as “discarded latent tokens.” The latent token subset 240 is also referred to herein as “conditioning information” and a “latent conditioning factor,” and is denoted herein as z_{cond}. For explanatory purposes, in some embodiments, including some embodiments depicted and described in conjunction with in FIG. 2, eight latent tokens z⁽¹⁾-z^{(B)} are included in the latent token subset 240, and the remaining latent tokens z⁽⁹⁾-z^{(M)} are discarded.

As shown, in some embodiments, the conditioning mechanism 144 is a FiLM generator that conditions the representation network 146 based on the latent token subset 240. In the same or other embodiments, for each latent token in the latent token subset 240, the conditioning mechanism 144 computes values for a data-dependent scale parameter and a data-dependent shift parameter associated with a corresponding FiLM layer included in the representation network 146. A data-dependent shift parameter is also referred to herein as a “data-dependent bias parameter.”

More specifically, in some embodiments, the conditioning mechanism 144 maps the latent tokens z⁽¹⁾-z^{(g)} to data-dependent scale parameters denoted as γ(z⁽¹⁾)-γ(z⁽⁸⁾), respectively, and data-dependent bias parameters denoted as β(z⁽¹⁾)-β(z⁽⁸⁾), respectively, of a FiLM layer 286(1)-a FiLM layer 286(8), respectively. The data-dependent scale parameters are denoted herein collectively as γ(z_{cond}), and the data-dependent bias parameters are denoted herein collectively as β(z_{cond}).

In some embodiments, the representation network 146 implements an implicit function to map each spectral position in an input vector to a different predicted visibility in an output vector. In the same or other embodiments, the representation network 146 is an MLP-based neural field having any number and/or types of learnable parameters (not shown) and any number and/or types of data-dependent parameters. The learnable parameters associated with the representation network 146 are denoted herein collectively as Or. As shown, in some embodiments, the data-dependent parameters associated with the representation network 146 are the data-dependent scale parameters γ(z_{cond}) and the data-dependent bias parameters β(z_{cond}). The implicit function implemented by the representation network 146 in some embodiments is parameterized by θᵣ, conditioned based on the latent token subset 240 z_{cond}, and denoted in the context of FIG. 2 as Φ(u,v;θᵣ;z_{cond}).

As shown, in some embodiments, the representation network 146 includes, without limitation, a positional encoding layer 282(1), a positional encoding layer 282(2), an MLP layer 284(1)-an MLP layer 284(8), a skip connection 288, and the FiLM layer 286(1)-the FiLM layer 286(8). In some embodiments, the positional encoding layer 282(1) and the positional encoding layer 282(2) are different instances of a positional encoding layer that maps the input vector of spectral positions into a vector of embeddings. The positional encoding layer can implement any type of positional encoding. For instance, in some embodiments, the positional encoding layer maps each spectral position in the input vector of spectral positions to a sinusoidal embedding via axis-aligned powers-of-two frequencies to facilitate learning high frequency information.

In some embodiments, the MLP layer 284(1)-the MLP layer 284(8) are fully connected layers, and the skip connection 288 feeds the input vector to the MLP layer 284(5) via the positional encoding layer 282(2). In the same or other embodiments, the FiLM layer 286(1)-the FiLM layer 286(8) are conditioning layers that precede and modulate the MLP layer 284(1)-the MLP layer 284(8), respectively. In some embodiments, for an integer i from 1 through 8, the FiLM layer 286(i) modulates the MLP layer 284(i) through a data-dependent scale and a data-dependent bias to the activation of the MLP layer 284(i) that is denoted herein as x⁽ⁱ⁾. More specifically, in some embodiments, the FiLM layer 286(i) modulates x⁽ⁱ⁾ to generate FiLM(x⁽ⁱ⁾) as per equation (5):

FiLM(x⁽ⁱ⁾)=γ(z⁽ⁱ⁾)□x⁽ⁱ⁾+β(z⁽ⁱ⁾) (5)

As described previously herein in conjunction with FIG. 1, as the training application 130 trains the spectral reconstruction model 140 in some embodiments, the training application 130 iteratively updates the values for the learnable parameters in the spectral reconstruction model 140 to reduce or minimize the reconstruction loss in the spectral domain as per the reconstruction loss function 136. During each iteration, to compute the reconstruction loss in some embodiments, the training application 130 sets the sparse visibility data points 122(1) to a training set of sparse visibility data points corresponding to a selected interferometric observation of a selected training astronomical object and inputs the sparse visibility data points 122(1) into the targeting network 142.

As shown in FIG. 2, in some embodiments, the targeting network 142 maps the sparse visibility data points 122(1) to the latent tokens z⁽¹⁾-z⁽⁸⁾. The conditioning mechanism 144, maps the latent tokens z⁽¹⁾-z⁽⁸⁾ to values for the data-dependent parameters γ(z⁽¹⁾)-γ(z⁽⁸⁾ and β(z⁽¹⁾)-β(z⁽⁸⁾) that modulate the representation network 146. As a result, the representation network 146 is a conditioned representation network that maps spectral positions to predicted visibilities for the selected training astronomical object.

To evaluate the reconstruction loss associated with the selected interferometric observation, in some embodiments, the training application 130 sets the dense ground-truth visibilities 124 equal to the ground-truth set of dense visibilities associated with the selected interferometric observation and included in the training database 120. As described previously herein in conjunction with FIG. 1, in some embodiments, the dense ground-truth visibilities 124 correspond to the dense spectral positions 132(1) that include, without limitation, N spectral positions, where N is significantly greater than M.

In some embodiments, the training application 130 inputs the dense spectral positions 132(1) into the representation network 146. In response, the representation network 146 maps the dense spectral positions 132(1) to the dense predicted visibilities 148(1). In some embodiments, the dense predicted visibilities 148(1) therefore include, without limitation, N predicted visibilities. For explanatory purposes, the dense spectral positions 132(1) are denoted herein individually as (u_{d1},v_{d1})-(u_{dN},v_{dN}), the dense ground-truth visibilities 124 are denoted herein individually as V_{GT}(u_{d1},v_{d1})-V_{GT}(u_{dN},v_{dN}), and the dense predicted visibilities 148(1) are denoted herein individually as \tilde{V}(u_{d1},v_{d1})-\tilde{V}(u_{dN},v_{dN}).

Referring back to FIG. 1, in some embodiments, the training application 130 uses the reconstruction loss function 136 to compute a reconstruction loss associated with the selected interferometric observation based on the dense ground-truth visibilities 124 and the dense predicted visibilities 148(1). In the same or other embodiments, computing the reconstruction loss associated with the selected interferometric observation via the reconstruction loss function 136 yields a mean-squared reconstruction error for N spectral positions included in the dense spectral positions 132(1).

In some embodiments, the reconstruction error associated each spectral position is equal to the predicted visibility for the spectral position that is included in the dense spectral positions 132(1) minus the ground-truth visibility for the spectral position that is included in the dense ground-truth visibilities 124. Accordingly, in some embodiments, the training application 130 iteratively and jointly optimizes the learnable parameters θₜ and θᵣ as per equations (6a) and (6b):

Σᵢ₌₁^{N}|Φ(u_{di}, [symbol] _{di};θᵣ;z_{cond})−V_{GT}(u_{di}, [symbol] _{di})|² (6a)

z_{cond}=ψ({uₛ,vₛ,\hat{V}(uₛ,vₛ)};θₜ) (6b)

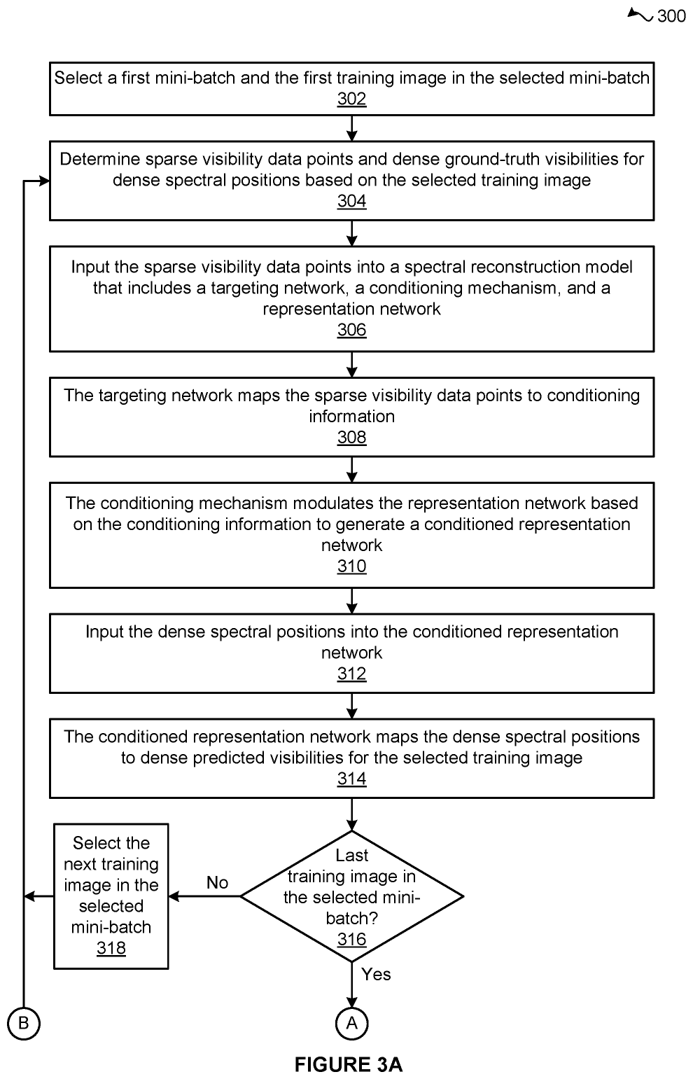

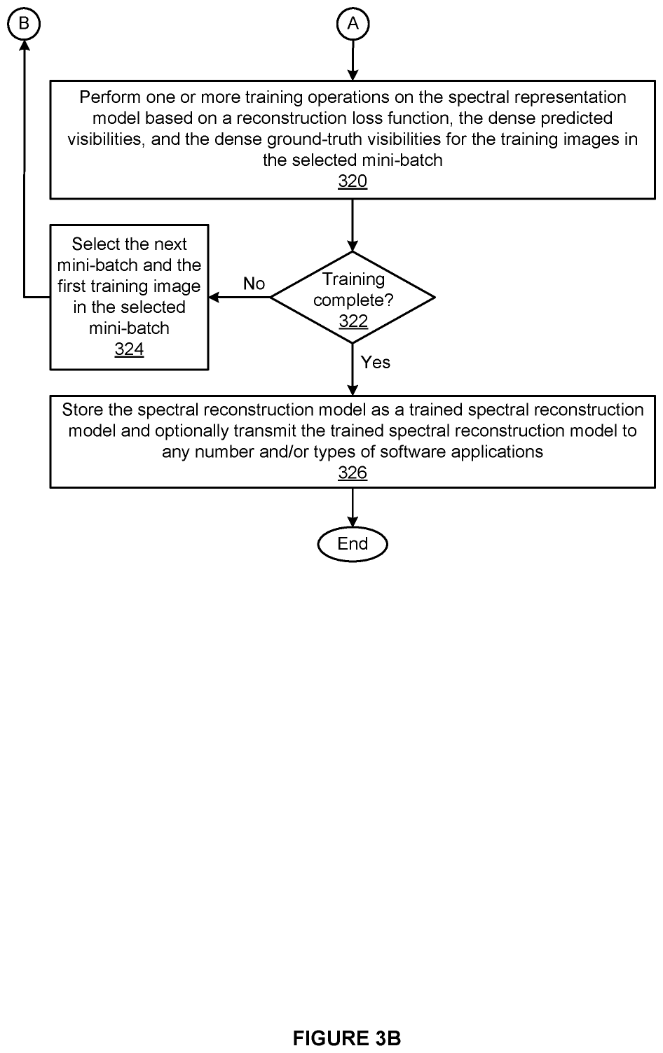

FIGS. 3A-3B set forth a flow diagram of method steps for training a machine learning model to map spectral positions to predicted visibilities for an astronomical object, according to various embodiments. Although the method steps are described with reference to the systems of FIGS. 1 and 2, persons skilled in the art will understand that any system configured to implement the method steps, in any order, falls within the scope of the present invention.

As shown, a method 300 begins at step 302, where the training application 130 selects a first mini-batch and a first training image in the selected mini-batch. At step 304, the training application 130 determines the sparse visibility data points 122(1) and the dense ground-truth visibilities 124 for the dense spectral positions 132(1) based on the selected training image. At step 306, the training application 130 inputs the sparse visibility data points 122(1) into the spectral reconstruction model 140 that includes, without limitation, the targeting network 142, the conditioning mechanism 144, and the representation network 146.

At step 308, the targeting network 142 maps the sparse visibility data points 122(1) to conditioning information. At step 310, the conditioning mechanism 144 modulates the representation network 146 based on the conditioning information to generate a conditioned representation network. At step 312, the training application 130 inputs the dense spectral positions 132(1) into the conditioned representation network. At step 314, the conditioned representation network maps the dense spectral positions 132(1) to dense predicted visibilities 148(1) for the selected training image.

At step 316, the training application 130 determines whether the selected training image is the last training image in the selected mini-batch. If, at step 316, the training application 130 determines that the selected training image is not the last training image in the selected mini-batch, then the method 300 proceeds to step 318. At step 318, the training application 130 selects the next training image in the selected mini-batch. The method 300 then returns to step 304, where the training application 130 determines the sparse visibility data points 122(1) and the dense ground-truth visibilities 124 for the dense spectral positions 132(1) based on the selected training image.

If, however, at step 316, the training application 130 determines that the selected training image is the last training image in the selected mini-batch, then the method 300 proceeds directly to step 320. At step 320, the training application 130 performs one or more training operations on the spectral reconstruction model 140 based on the reconstruction loss function 136 and the dense predicted visibilities 148(1) and the dense ground-truth visibilities 124 for the training images in the selected mini-batch.

At step 322 the training application 130 determines whether the training of the spectral reconstruction model 140 is complete. If, at step 322, the training application 130 determines that the training of the spectral reconstruction model 140 is not complete, then the method 300 proceeds to step 324. At step 324, the training application 130 selects the next mini-batch and a first training image in the selected mini-batch. The method 300 then returns to step 304, where the training application 130 determines the sparse visibility data points 122(1) and the dense ground-truth visibilities 124 for the dense spectral positions 132(1) based on the selected training image.

If, however, at step 322, the training application 130 determines that the training of the spectral reconstruction model 140 is complete, then the method 300 proceeds directly to step 326. At step 326, the training application 130 stores the spectral reconstruction model 140 as the trained spectral reconstruction model 150 and optionally transmits the trained spectral reconstruction model 150 to any number and/or types of software applications. The method 300 then terminates.

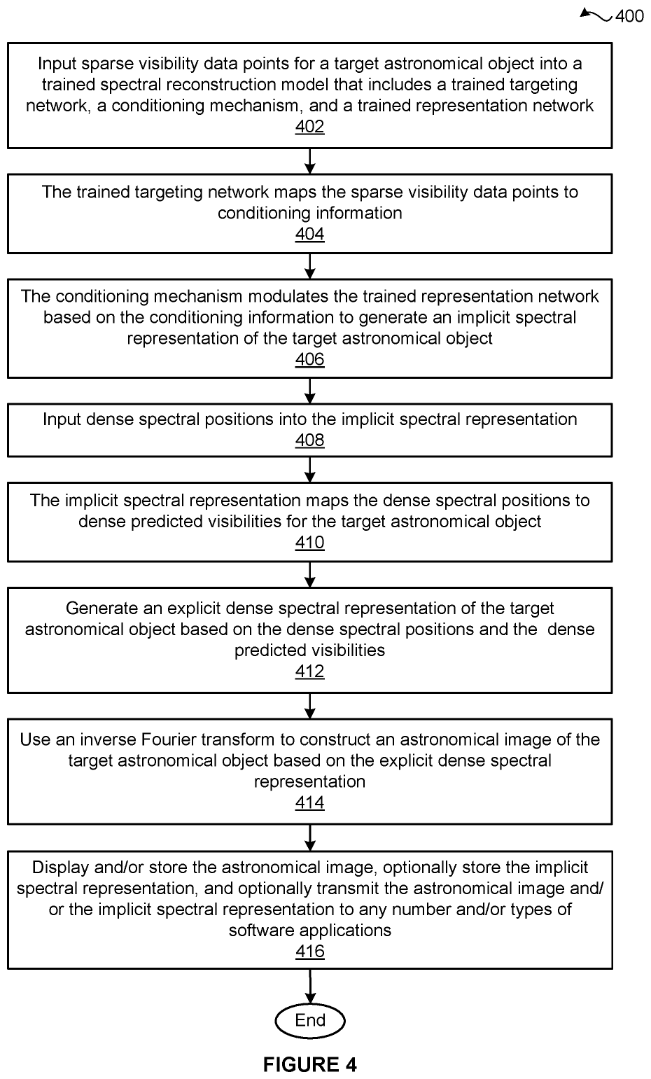

FIG. 4 is a flow diagram of method steps for generating an astronomical image using a trained machine learning model, according to various embodiments. Although the method steps are described with reference to the systems of FIGS. 1 and 2, persons skilled in the art will understand that any system configured to implement the method steps, in any order, falls within the scope of the present invention.

As shown, a method 400 begins at step 402, where the inference application 160 inputs the sparse visibility data points 122(2) for a target astronomical object into the trained spectral reconstruction model 150 that includes, without limitation, the trained targeting network 152, the conditioning mechanism 144, and the trained representation network 156.

At step 404, the trained targeting network 152 maps the sparse visibility data points 122(2) to conditioning information. At step 406, the conditioning mechanism 144 modulates the trained representation network 156 based on the conditioning information to generate the implicit spectral representation 170 of the target astronomical object.

At step 408, the inference application 160 inputs the dense spectral positions 132(2) into the implicit spectral representation 170. At step 410, the implicit spectral representation 170 maps the dense spectral positions 132(2) to dense predicted visibilities 148(2) for the target astronomical object. At step 412, the inference application 160 generates the explicit dense spectral representation 188 of the target astronomical object based on the dense spectral positions 132(2) and the dense predicted visibilities 148(2) for the target astronomical object.

At step 414, the spectral-to-spatial application 190 uses an inverse Fourier transform to construct astronomical image 198 of the target astronomical object based on the explicit dense spectral representation 188. At step 416, the spectral-to-spatial application 190 displays and/or stores the astronomical image 198, optionally stores the implicit spectral representation 170, and optionally transmits the astronomical image 198 and/or the implicit spectral representation 170 to any number and/or types of software applications. The method 400 then terminates.

In sum, the disclosed techniques can be used to generate accurate astronomical images based on sparsely sampled visibilities. In some embodiments, a training application trains a spectral reconstruction model to map a set of sparsely sampled visibilities to a dense, implicit spectral representation in the Fourier domain based on a synthetically generated training database. The synthetically generated training database is associated with T astronomical images and includes, without limitation, T training sets of sparse visibility data points and T ground-truth sets of visibilities corresponding to a set of dense spectral positions. Each training set includes, without limitation, M visibility data points, where M can be any integer. Each visibility data point is a tuple that specifies, without limitation, a u-coordinate, a v-coordinate, and a corresponding visibility. The set of dense spectral positions includes, without limitation, N spectral positions, where N is significantly greater than M. Each spectral position is an ordered pair of a u-coordinate and a v-coordinate, The ground-truth set includes, without limitation, N ground-truth visibilities.

The spectral reconstruction model includes, without limitation, a transformer-based encoder, a FiLM generator, and an MLP-based neural field. The transformer-based encoder maps a set of sparsely sampled visibility data points to latent tokens. The FiLM generator conditions the MLP-based neural field based on the latent tokens. The MLP-based neural field approximates an implicit function Φ(u, v) that is parameterized by learnable parameters associated with the MLP-based neural field and conditioned by the latent tokens. The implicit function Φ(u, v) maps a spectral position to a predicted visibility at the spectral position.

During each training iteration, a training application selects one of the T training images, the corresponding training set, and the corresponding ground-truth set. The training application inputs the M visibility data points in the selected training set into the transformer-based encoder. In response, the transformer-based encoder maps the M visibility data points to M visibility tokens. The transformer-based encoder then maps the M visibility tokens to M latent tokens via multi-heads self-attention layers. For each of the first J latent tokens, the FiLM generator modulates a different layer of the MLP-based neural field, thereby generating a conditioned MLP-based neural field.

To compute a reconstruction loss in the frequency domain, the training application inputs the dense spectral positions into the conditioned MLP-based neural field. In response, the neural implicit MLP maps the N dense spectral positions to N predicted visibilities. The training application computes a reconstruction loss in the frequency domain based on the N predicted visibilities and the N ground-truth visibilities in the selected ground-truth set. The training application jointly optimizes learnable parameters associated with the neural implicit MLP and learnable parameters associated with the transformer-based encoder to reduce or minimize the reconstruction loss in the frequency domain.

After the spectral reconstruction model is trained, an inference application maps M sparse visibility data points associated with an interferometric observation of a target astronomical object over time to latent tokens via the trained transformer-based encoder. The FilM generator conditions the MLP-based neural field to implement an implicit representation of the target astronomical object in the Fourier domain as per the latent tokens. The implicit representation can then be separated from the trained transformer-based encoder and the FiLM generator. The inference application generates and inputs a dense grid of points into the targeted neural implicit MLP to generate a dense grid of predicted visibilities for the target astronomical object. A spectral-to-spatial application uses an inverse 2D Fourier transform to construct an astronomical image for the target astronomical object based on the dense predicted visibilities and the dense spectral positions.

In some embodiments, a spectral-to-spatial application or any other type of software application uses the inverse Fourier transform to generate an accurate astronomical image of the target item based on the dense predicted values in the spectral domain for the target item.

As noted previously herein, the spectral reconstruction model, the training application, the inference application, the spectral-to-spatial application, or any combination thereof can be modified to perform sparse-to-dense reconstruction of spectral data to solve many other technical problems associated with a wide range of fields. More generally, a spectral reconstruction model includes, without limitation, any type of targeting networks and any number and/or types of representation networks, where the targeting network(s) modulate the representation network(s) in any technically feasible fashion. The training application trains the spectral reconstruction model in an end-to-end fashion to map positions in a spectral domain to predicted values in the spectral domain based on training sets of sparse spectral data points and corresponding ground-truth sets of dense ground-truth values in the spectral domain. Each spectral data point is a tuple that specifies, without limitation, 2D coordinates specifying a spectral position and a corresponding value in the spectral domain. After training, an inference application uses the targeting network(s) to condition the representation network(s) to implement an implicit spectral representation associated with both the spectral domain and a target item based on sparse spectral data points associated with a target item. The inference application inputs dense spectral positions into the implicit spectral representation to generate dense predicted values in the spectral domain for the target item. In some embodiments, a spectral-to-spatial application or any other type of software application converts the dense predicted values in the spectral domain to dense predicted values in the spatial domain, thereby generating a predicted image that is associated with the target item.

In the context of magnetic resonance imaging (MRI), in some embodiments, the training application trains a spectral reconstruction model to map positions in 2D k-space to predicted values based on sets of sparse measurements of radio frequency (RF) signals. Each set of sparse “MRI” measurements corresponds to actual or simulated observations of a different body organ via MRI. Some examples of body organs include, without limitation, internal body organs, portions of body tissue, blood vessels, muscles, and bones. As persons skilled in the art will recognize, “2D k-space” refers to a 2D Fourier transform of a magnetic resonance (MR) image. After training, an inference application uses the trained targeting network to condition a trained representation network based on a set of RF signals associated with an observation of a target body organ. The resulting conditioned trained representation is an implicit representation of the target body organ in 2D k-space. The inference application generates and inputs a dense grid of positions in k-space into the customized neural implicit MLP to generate a dense grid of predicted values in k-space for the target body organ. In some embodiments, a spectral-to-spatial application uses an inverse 2D Fourier transform to construct an MR image for the target body organ based on the dense k-space values for the target body organ.

Modifications on the disclosed techniques to map sparse spectral data points associated with different types of medical imaging to corresponding dense spectral representations that enable accurate construction of different types of medical images will be apparent to those of ordinary skill in the art. For instance, in some embodiments, the disclosed techniques are for instance, in some embodiments, the disclosed techniques are used to generate a medical image based on a sequence of projections associated with a computed tomography scan.

At least one technical advantage of the disclosed techniques relative to the prior art is that the disclosed techniques can be used to construct substantially more accurate images from sparsely sampled data relative to what can be achieved using prior art approaches. In the specific context of astronomical interferometry, the disclosed techniques are able to generate substantially more accurate images of a wider range of astronomical objects based on sparsely sampled visibilities relative to what can be achieved using conventional approaches. Among other things, in the disclosed approach, a machine learning model is trained to map sparsely sampled visibilities to an implicit dense representation in the Fourier domain. Because the trained machine learning model generates the implicit dense representation based on arbitrarily complex patterns gleaned from training data, the accuracy of an image generated using the disclosed techniques can be significantly increased relative to prior art approaches that implement simplifying assumptions that oftentimes prove to be quite limiting. Another advantage of the disclosed techniques is that, because the parameters associated with the machine learning model are automatically adjusted during training to reduce reconstruction errors, personal biases that can reduce the accuracy of prior art models are reduced. These technical advantages provide one or more technological advancements over prior art approaches.

1. In some embodiments, a computer-implemented method for representing items in a spectral domain comprises executing a first neural network on a first set of data points associated with both a first item and the spectral domain to generate a second neural network; generating a first set of predicted data points that are associated with both the first item and the spectral domain via the second neural network; and generating a trained machine learning model based on the first neural network, the second neural network, and the first set of predicted data points, wherein the trained machine learning model maps one or more positions within the spectral domain to one or more values associated with an item based on a set of data points associated with both the item and the spectral domain.

2. The computer-implemented method of clause 1, wherein executing the first neural network on the first set of data points comprises modifying a third neural network based on the first set of data points to generate the second neural network.

3. The computer-implemented method of clauses 1 or 2, wherein executing the first neural network on the first set of data points comprises computing one or more values for one or more parameters associated with the second neural network based on the first set of data points.

4. The computer-implemented method of any of clauses 1-3, wherein generating the first set of predicted data points comprises computing a set of predicted values corresponding to a set of positions within the spectral domain based on one or more learnable parameters included in the second neural network.

5. The computer-implemented method of any of clauses 1-4, wherein generating the first set of predicted data points comprises mapping a set of positions within the spectral domain to a set of predicted values in the spectral domain via the second neural network.

6. The computer-implemented method of any of clauses 1-5, wherein generating the trained machine learning model comprises modifying a first learnable parameter associated with the first neural network to reduce an error associated with the first set of predicted data points.

7. The computer-implemented method of any of clauses 1-6, wherein generating the trained machine learning model comprises modifying at least one learnable parameter associated with the second neural network based on the first set of predicted data points and a set of ground-truth values that are associated with both the first item and the spectral domain.

8. The computer-implemented method of any of clauses 1-7, wherein the spectral domain comprises a Fourier domain, a k-space, a cepstral domain, or a wavelet domain.

9. The computer-implemented method of any of clauses 1-8, wherein the first set of data points comprises a set of visibility data points, a set of magnetic resonance imaging measurements, or a set of surface measurements

10. The computer-implemented method of any of clauses 1-9, wherein the first item comprises an astronomical object, a body organ, a surface, or an image.

11. In some embodiments, one or more non-transitory computer readable media include instructions that, when executed by one or more processors, cause the one or more processors to represent items in a spectral domain by performing the steps of executing a first neural network on a first set of data points associated with both a first item and the spectral domain to generate a second neural network; generating a first set of predicted data points that are associated with both the first item and the spectral domain via the second neural network; and generating a trained machine learning model based on the first neural network, the second neural network, and the first set of predicted data points, wherein the trained machine learning model maps one or more positions within the spectral domain to one or more values associated with an item based on a set of data points associated with both the item and the spectral domain.

12. The one or more non-transitory computer readable media of clause 11, wherein executing the first neural network on the first set of data points comprises modifying a third neural network based on the first set of data points to generate the second neural network.

13. The one or more non-transitory computer readable media of clauses 11 or 12, wherein executing the first neural network on the first set of data points comprises computing at least one value for at least one parameter associated with a layer included in the second neural network based on the first set of data points.

14. The one or more non-transitory computer readable media of any of clauses 11-13, wherein generating the first set of predicted data points comprises computing a set of predicted values corresponding to a set of positions within the spectral domain based on a plurality of parameter values that are derived from the first set of data points and associated with the second neural network.

15. The one or more non-transitory computer readable media of any of clauses 11-14, wherein generating the first set of predicted data points comprises mapping a set of positions within the spectral domain to a set of predicted values in the spectral domain via the second neural network.

16. The one or more non-transitory computer readable media of any of clauses 11-15, wherein generating the trained machine learning model comprises modifying a first learnable parameter associated with the first neural network to reduce an error associated with the first set of predicted data points.

17. The one or more non-transitory computer readable media of any of clauses 11-16, wherein generating the trained machine learning model comprises modifying at least one learnable parameter associated with the second neural network based on the first set of predicted data points and a set of ground-truth values that are associated with both the first item and the spectral domain.

18. The one or more non-transitory computer readable media of any of clauses 11-17, wherein the first set of data points comprises a set of visibility data points, a set of magnetic resonance imaging measurements, or a set of surface measurements.

19. The one or more non-transitory computer readable media of any of clauses 11-18, further comprising performing one or more Fourier transform operations on an image associated with both the first item and a spatial domain to generate the first set of data points.

20. In some embodiments, a system comprises one or more memories storing instructions and one or more processors coupled to the one or more memories that, when executing the instructions, perform the steps of executing a first neural network on a first set of data points associated with both a first item and a spectral domain to generate a second neural network; generating a first set of predicted data points that are associated with both the first item and the spectral domain via the second neural network; and generating a trained machine learning model based on the first neural network, the second neural network, and the first set of predicted data points, wherein the trained machine learning model maps one or more positions within the spectral domain to one or more values associated with an item based on a set of data points associated with both the item and the spectral domain.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine.

The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for representing items in a spectral domain, the method comprising:
executing a first neural network on a first set of data points associated with both a first item and the spectral domain to generate a second neural network;
generating a first set of predicted data points that are associated with both the first item and the spectral domain via the second neural network; and
generating a trained machine learning model based on the first neural network, the second neural network, and the first set of predicted data points,
wherein the trained machine learning model maps one or more positions within the spectral domain to one or more values associated with an item based on a set of data points associated with both the item and the spectral domain.

2. The computer-implemented method of claim 1, wherein executing the first neural network on the first set of data points comprises modifying a third neural network based on the first set of data points to generate the second neural network.

3. The computer-implemented method of claim 1, wherein executing the first neural network on the first set of data points comprises computing one or more values for one or more parameters associated with the second neural network based on the first set of data points.

4. The computer-implemented method of claim 1, wherein generating the first set of predicted data points comprises computing a set of predicted values corresponding to a set of positions within the spectral domain based on one or more learnable parameters included in the second neural network.

5. The computer-implemented method of claim 1, wherein generating the first set of predicted data points comprises mapping a set of positions within the spectral domain to a set of predicted values in the spectral domain via the second neural network.

6. The computer-implemented method of claim 1, wherein generating the trained machine learning model comprises modifying a first learnable parameter associated with the first neural network to reduce an error associated with the first set of predicted data points.

7. The computer-implemented method of claim 1, wherein generating the trained machine learning model comprises modifying at least one learnable parameter associated with the second neural network based on the first set of predicted data points and a set of ground-truth values that are associated with both the first item and the spectral domain.

8. The computer-implemented method of claim 1, wherein the spectral domain comprises a Fourier domain, a k-space, a cepstral domain, or a wavelet domain.

9. The computer-implemented method of claim 1, wherein the first set of data points comprises a set of visibility data points, a set of magnetic resonance imaging measurements, or a set of surface measurements.

10. The computer-implemented method of claim 1, wherein the first item comprises an astronomical object, a body organ, a surface, or an image.

11. One or more non-transitory computer readable media including instructions that, when executed by one or more processors, cause the one or more processors to represent items in a spectral domain by performing the steps of:
executing a first neural network on a first set of data points associated with both a first item and the spectral domain to generate a second neural network;
generating a first set of predicted data points that are associated with both the first item and the spectral domain via the second neural network; and
generating a trained machine learning model based on the first neural network, the second neural network, and the first set of predicted data points,
wherein the trained machine learning model maps one or more positions within the spectral domain to one or more values associated with an item based on a set of data points associated with both the item and the spectral domain.

12. The one or more non-transitory computer readable media of claim 11, wherein executing the first neural network on the first set of data points comprises modifying a third neural network based on the first set of data points to generate the second neural network.

13. The one or more non-transitory computer readable media of claim 11, wherein executing the first neural network on the first set of data points comprises computing at least one value for at least one parameter associated with a layer included in the second neural network based on the first set of data points.

14. The one or more non-transitory computer readable media of claim 11, wherein generating the first set of predicted data points comprises computing a set of predicted values corresponding to a set of positions within the spectral domain based on a plurality of parameter values that are derived from the first set of data points and associated with the second neural network.

15. The one or more non-transitory computer readable media of claim 11, wherein generating the first set of predicted data points comprises mapping a set of positions within the spectral domain to a set of predicted values in the spectral domain via the second neural network.

16. The one or more non-transitory computer readable media of claim 11, wherein generating the trained machine learning model comprises modifying a first learnable parameter associated with the first neural network to reduce an error associated with the first set of predicted data points.

17. The one or more non-transitory computer readable media of claim 11, wherein generating the trained machine learning model comprises modifying at least one learnable parameter associated with the second neural network based on the first set of predicted data points and a set of ground-truth values that are associated with both the first item and the spectral domain.

18. The one or more non-transitory computer readable media of claim 11, wherein the first set of data points comprises a set of visibility data points, a set of magnetic resonance imaging measurements, or a set of surface measurements.

19. The one or more non-transitory computer readable media of claim 11, further comprising performing one or more Fourier transform operations on an image associated with both the first item and a spatial domain to generate the first set of data points.

20. A system comprising: one or more memories storing instructions; and
one or more processors coupled to the one or more memories that, when executing the instructions, perform the steps of:
executing a first neural network on a first set of data points associated with both a first item and a spectral domain to generate a second neural network;
generating a first set of predicted data points that are associated with both the first item and the spectral domain via the second neural network; and
generating a trained machine learning model based on the first neural network, the second neural network, and the first set of predicted data points,
wherein the trained machine learning model maps one or more positions within the spectral domain to one or more values associated with an item based on a set of data points associated with both the item and the spectral domain.
